(19) United States
(12) Patent Application Publication
(10) Pub. No.: US 2026/0000226 A1
(43) Pub. Date: Jan. 1, 2026

(54) ROTATIONALLY LOCKING CONTAINER

(71) Applicant: Yuhao Fang, Zhejiang (CN)

(72) Inventor: Yuhao Fang, Zhejiang (CN)

(21) Appl. No.: 19/271,767

(22) Filed: Jul. 16, 2025

Related U.S. Application Data
(63) Continuation of application No. PCT/CN2024/122635, filed on Sep. 30, 2024.

(30) Foreign Application Priority Data
Jun. 29, 2024 (CN) 202421517551.0

(51) Int. Cl. A47G 19/22; A47G 19/30; A47G 21/14; B65D 43/02; B65D 47/06; B65D 51/16; B65D 51/24; B65D 53/02; B65D 55/02

(52) U.S. Cl. CPC A47G 19/2272; A47G 19/2222; A47G 19/30; A47G 21/145; B65D 43/0202; B65D 47/06; B65D 51/16; B65D 51/246; B65D 53/02; B65D 55/02; B65D 2205/02; B65D 2255/20; B65D 2543/00194; B65D 2543/00398; B65D 2543/00972

(57) ABSTRACT

A rotationally locking container includes a body and a lid, with a sealing structure provided between the body and the lid. A rotational locking structure is provided between said body and said lid. The rotational locking structure includes a downwardly recessed rotating groove provided on the lid, a knob disposed within the rotating groove, and at least two outwardly extending locking tabs provided on the knob. The mouth of the body is provided with a protruding edge extending upwardly beyond the lid, and said protruding edge is provided with at least two locking holes, wherein the locking tabs are configured to cooperate with the locking holes. Compared to existing containers on the market, the adoption of the rotational locking structure, wherein the cooperation between the locking tabs and the locking holes is less prone to wear, offers the advantages of simpler operation, more reliable locking, and a longer service life.

### CROSS-REFERENCE TO RELATED APPLICATIONS

This application is a continuation of PCT Patent Application No. PCT/CN2024/122635, filed on Sep. 30, 2024, entitled “ROTARY LOCKING TYPE FRESH-KEEPING BOX,” which claims foreign priority of Chinese Patent Application No. 202421517551.0, filed Jun. 29, 2024 in the China National Intellectual Property Administration (CNIPA), the entire contents of which are hereby incorporated by reference in their entireties.

### BACKGROUND

### Technical Field

The present invention relates to containers, and more specifically, to a rotationally locking container, belonging to the field of containers.

### Description of Related Art

There are numerous types of food containers on the market, such as food storage containers, sealed boxes, and drinking cups. Taking a food storage container as an example, its basic structure typically consists of a box body and a lid. A sealing ring is provided on the lid, and when the lid is placed on the body, it is fastened by a clasping structure. Under the action of the sealing ring, the interior of the box body is kept sealed to achieve the purpose of food preservation.

Currently, common clasping structures include providing clasping ears on the lid and retaining ribs on the box body, wherein the clasping ears fasten onto the retaining ribs. As food storage containers are generally made of plastic materials, after prolonged use, the clasping ears and retaining ribs can suffer from wear or aging, leading to a failure to securely fasten the lid to the body. Consequently, the food storage container can no longer maintain a seal, defeating its purpose of preservation. The reliance on flexible plastic clasps that engage through interference fits leads to material fatigue and eventual failure, which is a known deficiency in the art.

### SUMMARY

The present disclosure provides a rotationally locking container configured to provide a firm, reliable, and durable lock, overcoming the disadvantages of prior art clasping mechanisms. The container comprises a body and a lid, with a sealing structure and a rotational locking structure provided therebetween.

The rotational locking structure comprises a downwardly recessed rotating groove provided on the lid, a knob disposed within the rotating groove, and at least two outwardly extending locking tabs provided on the knob. The mouth of the body is provided with a protruding edge extending upwardly beyond the lid, and the protruding edge is provided with at least two locking holes configured to cooperate with the locking tabs.

In operation, a user turns the knob, causing the locking tabs to rotate and engage the locking holes, thereby securing the lid to the body. This mechanism, which relies on the engagement of rigid tabs within defined apertures, is less prone to the wear and material fatigue that affects conventional clasps, offering simpler operation, more reliable locking, and a longer service life.

In various embodiments, the container may include additional features to enhance functionality. These can include a detent structure to provide tactile feedback and defined positions for the knob, a venting system actuated by the rotation of the knob to release pressure, and an integrated sealing structure to ensure airtightness. The versatile design allows the container to be embodied as a food storage container, a sealed box, or a drinking cup with a mouthpiece integrated into the knob mechanism.

### BRIEF DESCRIPTION OF THE DRAWINGS

FIG. 1 is a schematic perspective view of a rotationally locking container according to the present invention, embodied as a food storage container or a sealed box.

FIG. 2 is a schematic view of the lid of the present invention.

FIG. 3 is a schematic view of the knob of the present invention.

FIG. 4 is a schematic cross-sectional view of the food storage container or sealed box of the present invention.

FIG. 5 is a schematic perspective view of a rectangular food storage container or sealed box of the present invention.

FIG. 6 is a schematic perspective view of a square food storage container or sealed box of the present invention.

FIG. 7 is a schematic perspective view of a food storage container or sealed box of the present invention having two locking tabs.

FIG. 8 is a schematic cross-sectional view of a rotationally locking container according to the present invention, embodied as a drinking cup.

FIG. 9 is a schematic exploded view showing the correspondence between the mouthpiece and the water outlet of the drinking cup embodiment of the present invention.

FIG. 10 is a schematic exploded view showing the correspondence between the sealing gasket and the water outlet of the drinking cup embodiment of the present invention.

### DESCRIPTION OF THE EMBODIMENTS

The present invention will be described in further detail below in conjunction with specific embodiments and the accompanying drawings. The following embodiments will assist those skilled in the art in further understanding the present invention but do not limit the present invention in any form.

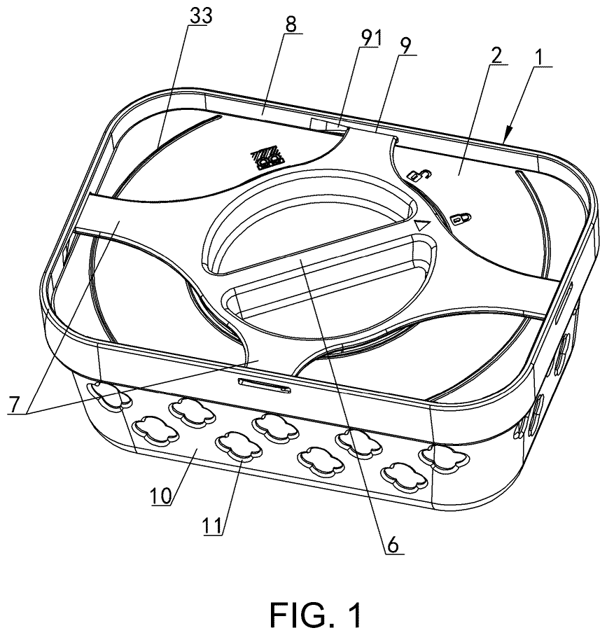

As shown in FIG. 1 to FIG. 7, an embodiment of the rotationally locking container comprises a body 1 and a lid 2. A sealing structure is provided between the body 1 and the lid 2 to ensure the contents are isolated from the external environment.

A rotational locking structure is provided between the body 1 and the lid 2. The rotational locking structure comprises a downwardly recessed rotating groove 5 provided on the lid 2, and a knob 6 disposed within the rotating groove 5. The knob 6 is provided with at least two outwardly extending locking tabs 7.

The mouth of the body 1 is provided with a protruding edge 8 that extends upwardly beyond the lid 2 when the lid is in a closed position. The protruding edge 8 is provided with at least two locking holes 9. The locking tabs 7 are configured to cooperate with the locking holes 9 to lock the lid 2 to the body 1.

To lock the container, the knob 6 is turned by hand, causing the knob 6 to drive the locking tabs 7 to rotate and enter their corresponding locking holes 9, thereby securely locking the lid 2 to the body 1. To open the lid 2, the knob 6 is simply turned in the reverse direction, causing the locking tabs 7 to withdraw from the locking holes 9. This rotational mechanism provides simpler operation, more reliable locking, and a longer service life compared to conventional clasping structures that rely on flexing plastic parts.

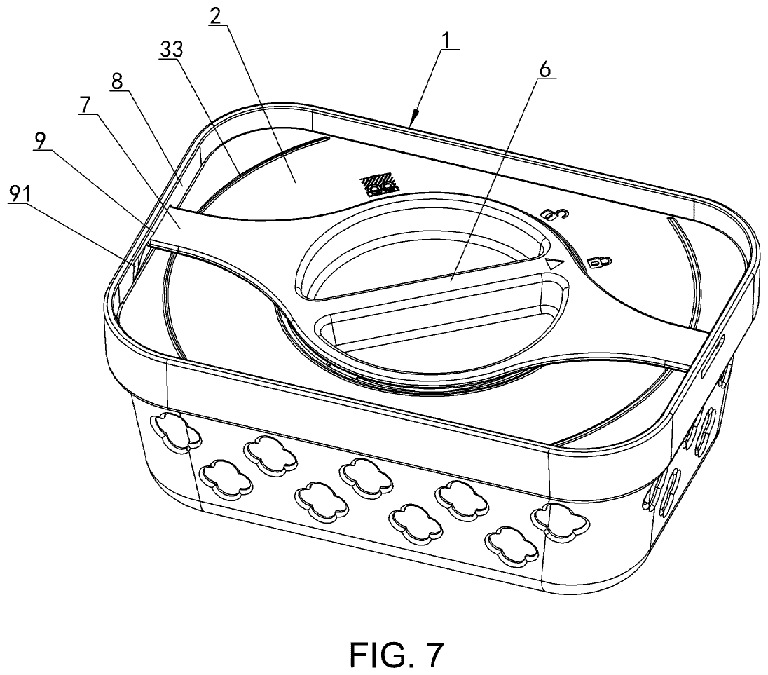

The locking tabs 7 may be provided in various numbers and configurations depending on the shape and size of the container. In a first embodiment, shown in FIG. 7, the body 1 and lid 2 are rectangular or square, and two locking tabs 7 are arranged linearly in a front-back or left-right configuration. The number and distribution of the locking holes 9 correspond to the locking tabs 7.

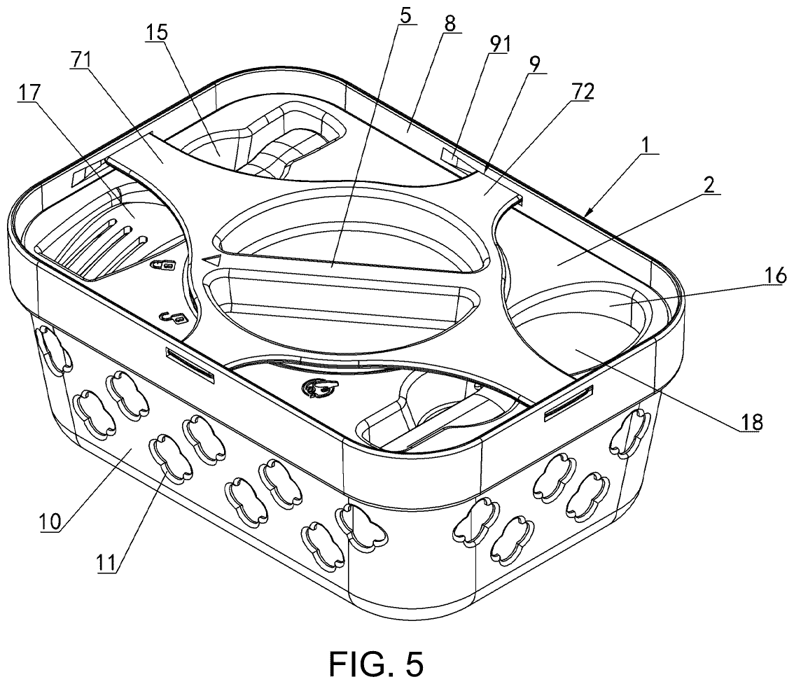

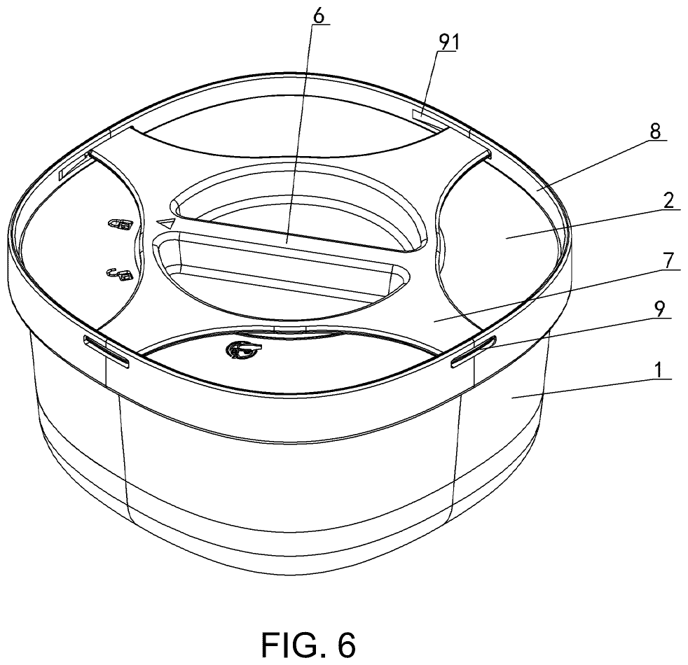

In a second embodiment, shown in FIGS. 5 and 6, the body 1 and lid 2 are rectangular or square, and four locking tabs 7 are arranged in a cross-shaped distribution. The protruding edge 8 is provided with four corresponding locking holes 9 to engage with the tabs.

In a third embodiment, particularly for a rectangular container as depicted in FIG. 5, the four locking tabs 7 may comprise two symmetrical long locking tabs 71 and two symmetrical short locking tabs 72. This configuration can provide differential locking force or accommodate specific container geometries. The number and distribution of the locking holes 9 correspond to these long and short locking tabs.

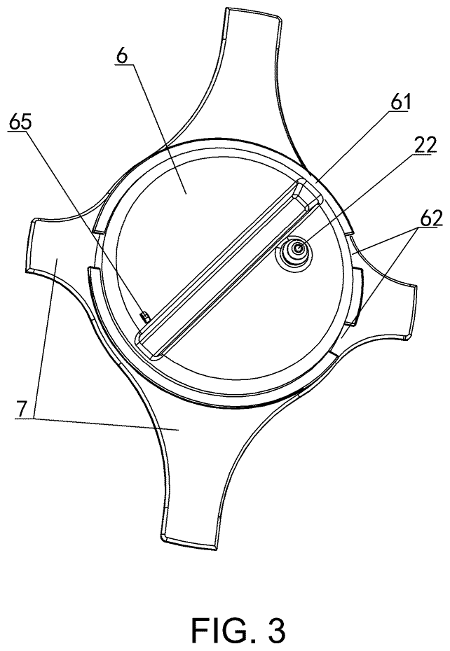

As shown in FIG. 3, a detent structure may be provided between the knob 6 and the rotating groove 5 to provide tactile feedback and hold the knob in defined rotational positions. The detent structure comprises a limiting convex ring 61 on the outer wall of the knob 6. This ring is provided with three notches 62 arranged, for example, in a triangular distribution. The inner wall of the rotating groove 5 is provided with corresponding limiting plates 51.

The cooperation between the limiting plates 51 and the limiting convex ring 61 retains the knob 6 within the rotating groove 5 during normal operation. For assembly or disassembly, the knob 6 can only be inserted into or removed from the rotating groove 5 when the limiting plates 51 are aligned with the notches 62.

To provide clear user feedback on the state of the container, the bottom surface of the knob 6 can be provided with a positioning block 65. The bottom surface of the rotating groove 5 is correspondingly provided with a locked-positioning block 55, an unlocked-positioning block 56, and a release-positioning block 57. An arrow 66 or other indicator on the surface of the knob 6 aligns with a corresponding locked-state indicator 58, an unlocked-state indicator 59, and a release-state indicator 54 on the surface of the lid 2 to signify the current function that has been activated.

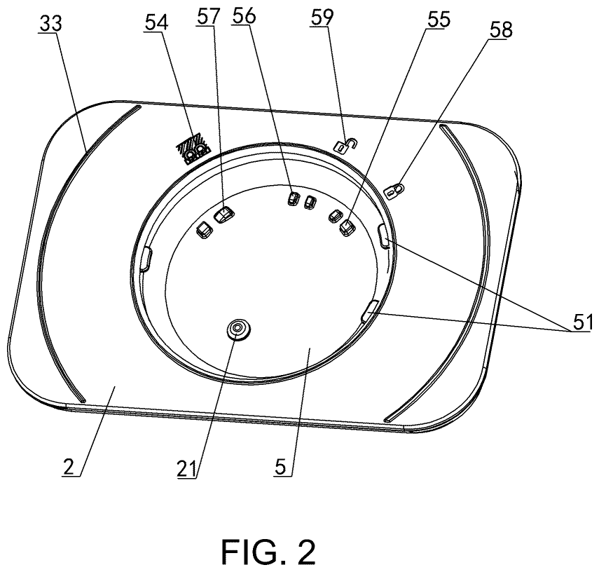

As shown in FIG. 2, the bottom of the rotating groove 5 may be further provided with a vent hole 21. The bottom surface of the knob 6 is provided with a vent-actuating block 22 configured to cooperate with the vent hole 21. When the knob 6 is turned to the locked-state indicator position, the vent-actuating block 22 presses against and seals the vent hole 21, placing the entire container in a fully sealed state. When the knob is turned to the unlocked-state indicator position, the vent-actuating block 22 separates from the vent hole 21, allowing air to be released, which can facilitate opening the container if a pressure differential exists.

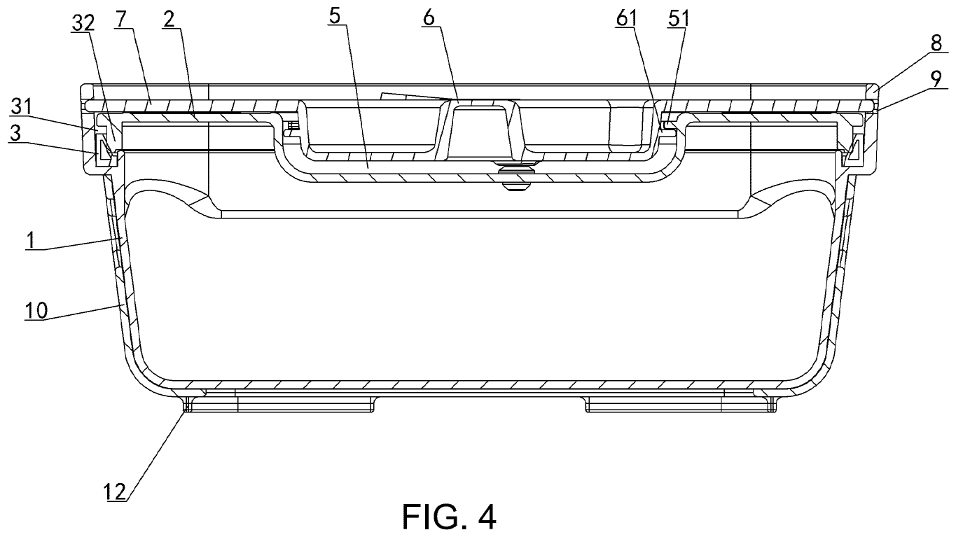

As shown in the cross-sectional view of FIG. 4, the sealing structure comprises a channel 31 provided on the inner wall of the rim of the mouth of the body 1. A sealing ring 3, which may have a triangular cross-section for effective compression, is disposed in the channel 31. A sealing pressure ring 32 is provided on the underside of the lid 2. When the lid 2 is closed and locked, the sealing pressure ring 32 presses against the sealing ring 3, creating a robust seal.

To facilitate the entry of the locking tabs 7 into the locking holes 9, one side edge of each locking hole 9 may be provided with an inclined surface 91. This ramped surface guides the tabs into the holes smoothly as the knob is rotated.

The lid 2 may be provided with a plurality of raised ribs 33, which are in contact with the bottom surface of the knob 6. The contact between these ribs and the knob prevents wear on the main surface of the lid, maintaining its appearance and smoothness of operation.

As shown in FIG. 1, the outer wall of the body 1 may be fitted with an outer shell 10. This outer shell can have hollowed-out openings 11 for an aesthetically pleasing appearance and to reduce material usage. The bottom of the outer shell 10 may be provided with feet 12 for stable placement and to facilitate the stacking of multiple containers.

For additional convenience, particularly in embodiments such as a lunchbox, the lid 2 may be provided with a fork slot 15 and a knife slot 16, wherein a fork 17 and a knife 18 can be securely stored.

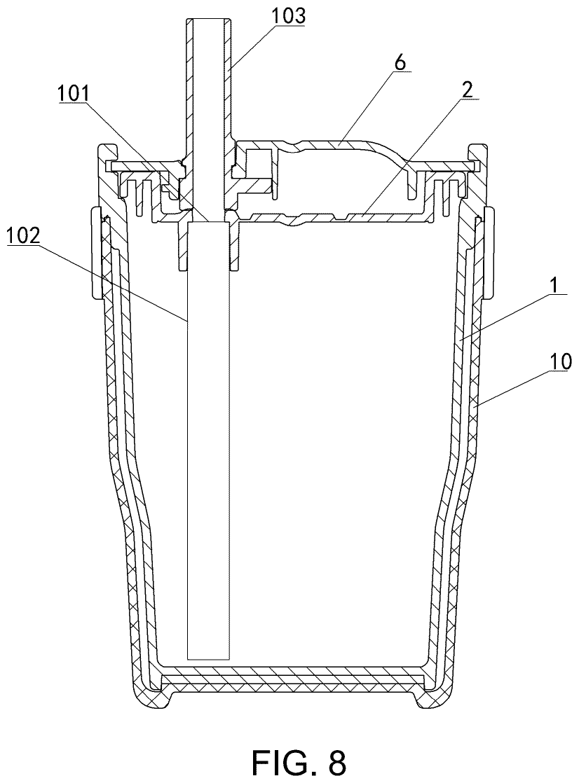

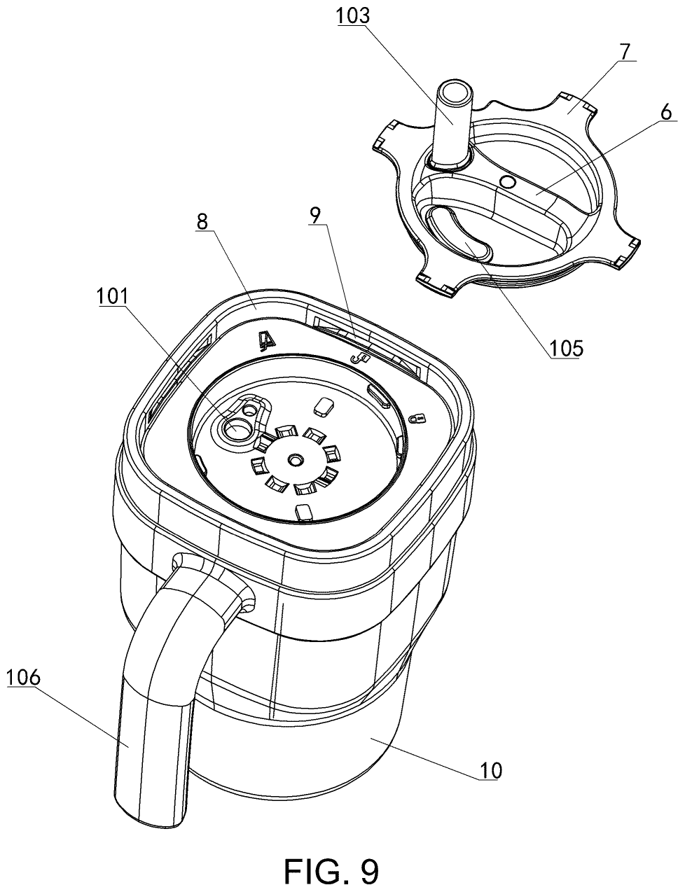

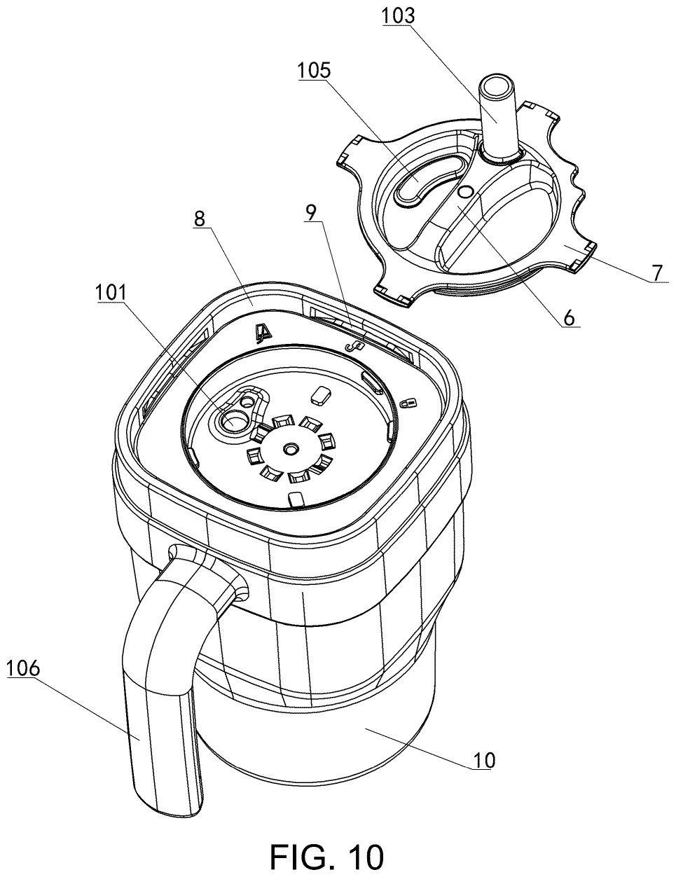

In another embodiment, the container is configured as a drinking cup, as shown in FIGS. 8-10. In this configuration, the lid 2 (acting as a cup lid) is provided with a water outlet 101.

A straw 102 is connected to the underside of the water outlet 101 and extends down into the body 1 (acting as a cup body). The knob 6 is provided with a mouthpiece 103 that is positioned to correspond with the water outlet 101 when the knob is in an open position. The mouthpiece 103 can be attached to the knob 6 via various methods, such as a snap-fit, a threaded connection, or by being integrally molded.

The knob 6 in the drinking cup embodiment is also provided with a sealing gasket 105. When the knob 6 is turned to a first, open position, the mouthpiece 103 aligns with the water outlet 101, allowing a user to suck water from the cup through the mouthpiece. When the knob 6 is turned to a second, closed position, the sealing gasket 105 is rotated into position to block and seal the water outlet 101, preventing spillage.

The outer shell 10 of the drinking cup embodiment may be provided with a handle 106 to facilitate carrying and use of the cup.

In the description of the present application, it is to be understood that terms indicating orientation or positional relationships are based on those shown in the accompanying drawings and are used merely for the convenience of describing the present application and simplifying the description, and should not be construed as limitations on the present patent.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The variations and modifications will be apparent to those skilled in the art.

What is claimed is:

1. A rotationally locking container, comprising:
a body;
a lid configured to close an opening of the body, wherein a sealing structure is provided between the body and the lid; and
a rotational locking structure provided between the body and the lid, the rotational locking structure comprising:
a downwardly recessed rotating groove provided on the lid;
a knob disposed within the rotating groove;
at least two outwardly extending locking tabs provided on the knob;
a protruding edge provided at a mouth of the body, the protruding edge extending upwardly beyond the lid when the lid is in a closed position; and
at least two locking holes provided on the protruding edge, wherein the locking tabs are configured to engage the locking holes upon rotation of the knob to lock the lid to the body.

2. The rotationally locking container of claim 1, wherein the body and the lid are rectangular or square, wherein the locking tabs comprise two locking tabs arranged linearly in a left-right or front-back configuration, and wherein a number and a distribution of the locking holes correspond to the two locking tabs.

3. The rotationally locking container of claim 1, wherein the body and the lid are rectangular or square, wherein the locking tabs comprise four locking tabs arranged in a cross-shaped distribution, and wherein a number and a distribution of the locking holes correspond to the four locking tabs.

4. The rotationally locking container of claim 3, wherein the body and the lid are rectangular, and wherein the four locking tabs comprise two symmetrical long locking tabs and two symmetrical short locking tabs, and wherein the number and the distribution of the locking holes correspond to the long and short locking tabs.

5. The rotationally locking container of claim 1, further comprising a detent structure provided between the knob and the rotating groove, the detent structure comprising:
a limiting convex ring provided on an outer wall of the knob, the limiting convex ring being provided with three notches arranged in a triangular distribution; and
corresponding limiting plates provided on an inner wall of the rotating groove, wherein the limiting plates are configured to cooperate with the limiting convex ring and the notches.

6. The rotationally locking container of claim 1, wherein a bottom surface of the knob is provided with a positioning block, wherein a bottom surface of the rotating groove is provided with a locked-positioning block, an unlocked-positioning block, and a release-positioning block, and wherein a surface of the knob is provided with an arrow, and a surface of the lid is provided with a corresponding locked-state indicator, an unlocked-state indicator, and a release-state indicator.

7. The rotationally locking container of claim 1, wherein the lid is provided with a plurality of raised ribs, the ribs being in contact with a bottom surface of the knob.

8. The rotationally locking container of claim 1, wherein a bottom of the rotating groove is further provided with a vent hole, and wherein a bottom surface of the knob is provided with a vent-actuating block configured to cooperate with the vent hole.

9. The rotationally locking container of claim 1, wherein one side edge of each of the locking holes is provided with an inclined surface.

10. The rotationally locking container of claim 1, wherein an outer wall of the body is fitted with an outer shell, the outer shell is provided with hollowed-out openings, and a bottom of the outer shell is provided with feet.

11. The rotationally locking container of claim 1, wherein the sealing structure comprises:
a channel provided on an inner wall of a rim of the mouth of the body;
a sealing ring with a triangular cross-section disposed in the channel; and
a sealing pressure ring provided on an underside of the lid, the sealing pressure ring being configured to cooperate with the sealing ring.

12. The rotationally locking container of claim 1, wherein the lid is further provided with a fork slot and a knife slot, wherein a fork is placed in the fork slot and a knife is placed in the knife slot.

13. The rotationally locking container of claim 1, wherein the container is a food storage container or a sealed box.

14. The rotationally locking container of claim 1, wherein the container is a drinking cup.

15. The rotationally locking container of claim 14, wherein the lid is provided with a water outlet, a straw is connected to an underside of the water outlet, the knob is provided with a mouthpiece, and the mouthpiece corresponds to the water outlet.

16. The rotationally locking container of claim 15, wherein the knob is provided with a sealing gasket, the sealing gasket being configured to cooperate with the water outlet.
